(19) United States
(12) Patent Application Publication
(10) Pub. No.: US 2009/0285965 A1
(43) Pub. Date: Nov. 19, 2009

(54) BEER-LIKE BEVERAGE AND METHOD FOR PREPARING THE SAME

(76) Inventor: Tony Liu, Heilongjiang (CN)

Correspondence Address: SEED INTELLECTUAL PROPERTY LAW GROUP PLLC, 701 FIFTH AVE, SUITE 5400, SEATTLE, WA, 98104, US

(21) Appl. No.: 12/296,271

(22) PCT Filed: Apr. 9, 2007
(86) PCT No.: PCT/CN2007/001147

§ 371 Date: Jul. 1, 2009

(30) Foreign Application Priority Data
Apr. 7, 2006 (CN) 200610009910.1

(51) Int. Cl. A23L 2/38

(52) U.S. Cl. 426/590

(57) ABSTRACT

A beer-like beverage and a method for preparing the same are disclosed. Said bear-like beverage is prepared by the following source materials: soybean peptide powder, sodium carboxymethylcellulose (CMC), carbon dioxide, sweeteners, acidity agents, preservatives, other optional auxiliary materials and balance of water. This beer-like beverage has a pH value of 3.6˜3.8, total acid of 0.28˜0.40 wt %, total sugar of less than 5 wt %, and sweetness of 9˜10°. The method for the preparation of this beverage comprises soybean peptide powder pretreatment, volume adjustment, carbonation, bottle filling and spraying sterilization.

### TECHNICAL FIELD

This application claims priority benefits of Chinese patent application No. 200610009910.1, filed on Apr. 7, 2006, which is incorporated by reference herein in its entirety.

The present invention relates to a beverage and a method for preparing the beverage. Specifically, this invention relates to a beer-like beverage and a method for preparing the beer-like beverage.

### BACKGROUND ART

Traditional beer, a kind of fermented wine, is carbon dioxide-contained, effervescent and low alcoholic. After adding hops (including hops products) and yeast fermentation, traditional beer can be brewed with some source materials, such as malt, rice, corn and water. The production technology of traditional beer is complex. A number of equipments and excessive occupied area are needed. Therefore initial investment is high. Source materials are mainly malt, rice, corn and etc. Take 12 degree beer for example. 1 ton of grain can produce 5 tons of beer. Grain cost is high while production rate is low. At present, functional beer market enlarges unceasingly and has entered the accelerated development period. Peptide beer and fruit beer are prepared by adding peptide or juice into traditional beer. Nutrition is increased or tastes are changed when compared with traditional beer, and more choices can be made by customers. However, no great breakthrough has been made.

### DESCRIPTION OF THE INVENTION

One object of this invention is to provide a beer-like beverage. Another object of this invention is to provide a method for preparing the beer-like beverage.

### 1. Formula

A beer-like beverage that is a mixture comprising, in terms of 100 parts by weight of the beverage, at least the following materials:

0.2˜0.9 parts by weight, preferably 0.2˜0.5 parts by weight of soybean peptide powder, 0.05˜0.15 parts by weight of sodium carboxymethylcellulose (CMC),

0.30˜0.65 parts by weight, preferably 0.4˜0.65 parts by weight of carbon dioxide,

1.5˜10 parts by weight, preferably 1.55˜2.65 parts by weight of sweeteners,

0.006˜0.3% parts by weight, preferably 0.016˜0.1045 parts by weight of acidity agents, and balance of water.

In an embodiment, the pH value of the beer-like beverage is 3.6˜4.8. Total acid is 0.18˜0.40 parts by weight. Total sugar is below 5 parts by weight and the sweetness is 9˜10°.

In an embodiment, the beer-like beverage comprises 0.2˜0.5 parts by weight of soybean peptide powder, 0.05˜0.15 parts by weight of sodium carboxymethylcellulose, 0.4˜0.65 parts by weight of carbon dioxide, 1.55˜2.65 parts by weight of sweeteners, 0.006˜0.3% parts by weight of acidity agents, and balance of water.

In an embodiment, the mixture comprises 0.2˜0.8 parts by weight of soybean peptide powder, 0.05˜0.15 parts by weight of sodium carboxymethylcellulose, 1.5˜7 parts by weight of high fructose syrup having a concentration of 71%, 0.04˜0.15 parts by weight of sodium cyclamate, 0.004˜0.005 parts by weight of acesulfame potassium, 0.01˜0.2 parts by weight of citric acid, 0.005˜0.025 parts by weight of phosphoric acid, 0.001˜0.02 parts by weight of sodium citrate, 0.4˜0.65 parts by weight of carbon dioxide and balance of water.

In an embodiment, besides those mentioned above, other source materials may also be added, such as 2 parts by weight of oligo-maltose, 0.1035 parts by weight of malic acid, 0.015 parts by weight of sodium benzoate, 0.0687 parts by weight of food flavor, and 0.00025 parts by weight of natural pigment.

In an embodiment, the mixture comprises 0.5˜0.8 parts by weight of soybean peptide powder, 0.05˜0.15 parts by weight of sodium carboxymethylcellulose, 6˜7 parts by weight of high fructose syrup having a concentration of 71%, 2 parts by weight of oligo-maltose, 0.04˜0.06 parts by weight of sodium cyclamate, 0.004˜0.005 parts by weight of acesulfame potassium, 0.15˜0.2 parts by weight of citric acid, 0.1035 parts by weight of malic acid, 0.01˜0.02 parts by weight of phosphoric acid, 0.01˜0.02 parts by weight of sodium citrate, 0.015 parts by weight of sodium benzoate, 0.0687 parts by weight of food flavor, and 0.00025 parts by weight of natural pigment.

In an embodiment, the mixture comprises 0.725 parts by weight of soybean peptide powder, 0.06 parts by weight of sodium carboxymethylcellulose, 6.5 parts by weight of high fructose syrup having a concentration of 71%, 2 parts by weight of oligo-maltose, 0.06 parts by weight of sodium cyclamate, 0.005 parts by weight of acesulfame potassium, 0.18 parts by weight of citric acid, 0.1035 parts by weight of malic acid, 0.02 parts by weight of phosphoric acid, 0.01 parts by weight of sodium citrate, 0.015 parts by weight of sodium benzoate, 0.0687 parts by weight of food flavor, and 0.00025 parts by weight of natural pigment.

Soybean peptide powders used in the preparation of the beer-like beverage according to the invention accord with QB/T2653-2004. Main source materials are soybean, soybean meal or soybean protein, and they are prepared by enzymolysis method or microbiological fermentation method. The soybean peptide powder is white or light yellow powder, and its main component is peptide with molecular weight below 10000 Dalton. Soybean protein peptide is a smaller molecular weight peptide. Besides rich nutrition and easy to absorption, it has the functions of decreasing blood pressure and cholesterol, improving lipid metabolism, preventing arteriosclerosis and accelerating the development of brain and nerve (see “Development of soybean protein peptide beer”, Beer Technology, Issue 10, 2006).

Sweeteners used in the preparation of the beer-like beverage according to the invention include but not limited to high fructose syrup, oligo-maltose, sodium cyclamate, acesulfame potassium, saccharin sodium, sodium cyclohexylsulfamate, isomaltulose, maltitol, sorbitol, xylitol, stevioside, glycyrrhiza, acesulfame-K, ammonium glycyrrhizate, lactitol, mogrosides or sucralose, sugar, aspartame, or mixtures of any two or more of these sweeteners. A mixture of high fructose syrup, polymaltose, sodium cyclamate and acesulfame potassium is preferred. A mixture of 6.5 parts by weight of high fructose syrup having a concentration of 71%, 2 parts by weight of oligo-maltose, 0.06 parts by weight of sodium cyclamate, and 0.005 parts by weight of acesulfame potassium is more preferred.

Acidity agents used in the preparation of the beer-like beverage according to the invention are malic acid, citric acid, sodium citrate, phosphoric acid, tartaric acid and lactic acid, or mixtures of any two or more of these acidity agents. A mixture of citric acid, malic acid and phosphoric acid is preferred, and a mixture of 0.18 parts by weight of citric acid, 0.1035 parts by weight of malic acid, 0.01 parts by weight of sodium citrate and 0.02 parts by weight of phosphoric acid is more preferred.

Preservatives used in the preparation of the beer-like beverage according to the invention are potassium sorbate, sodium benzoate, nisin, carbon dioxide, or mixtures of any two or more these preservatives. Sodium benzoate is preferred, especially 0.015 parts by weight of sodium benzoate.

Other auxiliary materials that can be added in the preparation of the beer-like beverage according to the invention include fruit flavor, juice, milk, milk powder, cereal crops, various vegetable juice, edible alcohol, honey, or mixtures of any two or more these materials. Fruit flavors mentioned above include but not limited to yellow peach, honey peach, peach or mint flavor, and the common addition amount is 0.03˜0.04 parts by weight; juices mentioned above include but not limited to orange juice, mandarin juice, pear juice, apple juice, strawberry juice, grape juice, pineapple juice, “Hami” melon juice, mango juice, watermelon juice, or peach juice, and the common addition amount is 2.5˜30 parts by weight; milk mentioned above include but not limited to fresh milk or reconstituted milk made by milk powder, and the common addition amount is 2.5˜30 parts by weight; the common addition amount of the edible alcohol mentioned above is 0.5˜4 parts by weight.

Other auxiliary materials that can be added in the preparation of the beer-like beverage according to the invention may also include sorbitol, L-carnitine tartaric acid, taurine, vitamin C, vitamin B1, vitamin B3, vitamin B6, ginsenoside, soybean milk flavor, vanillin, ethyl maltol, almond flavor, wheat flavor, baked barley, natural pigment, auxiliary materials or flavorings used in other beverage formulas, and mixtures of any two or more these materials or flavorings. The common addition amount is 0.015˜0.2 parts by weight.

Preferred materials used in the preparation of the beer-like beverage according to the invention include 0.5˜0.8 parts by weight of soybean peptide powder, 0.05˜0.15 parts by weight of sodium carboxymethylcellulose, 6˜7 parts by weight of high fructose syrup having a concentration of 71%, 2 parts by weight of oligo-maltose, 0.04˜0.06 parts by weight of sodium cyclamate, 0.004˜0.005 parts by weight of acesulfame potassium, 0.15˜0.2 parts by weight of citric acid, 0.1035 parts by weight of malic acid, 0.01˜0.02 parts by weight of phosphoric acid, 0.01˜0.02 parts by weight of sodium citrate, 0.015 parts by weight of sodium benzoate, 0.0687 parts by weight of food flavor, and 0.00025 parts by weight of natural pigment.

The most preferred materials used in the preparation of the beer-like beverage according to the invention include 0.725 parts by weight of soybean peptide powder, 0.06 parts by weight of sodium carboxymethylcellulose, 6.5 parts by weight of high fructose syrup having a concentration of 71%, 2 parts by weight of oligo-maltose, 0.06 parts by weight of sodium cyclamate, 0.005 parts by weight of acesulfame potassium, 0.18 parts by weight of citric acid, 0.1035 parts by weight of malic acid, 0.02 parts by weight of phosphoric acid, 0.01 parts by weight of sodium citrate, 0.015 parts by weight of sodium benzoate, 0.0687 parts by weight of food flavor, and 0.00025 parts by weight of natural pigment.

Total acid in the beer-like beverage according to the invention means organic acid contained in the beverage, and is calculated by citric acid.

Total sugar in the beer-like beverage according to the invention means the total amount of reducing substances generated throughout the hydrolysis of carbohydrate by inorganic acid, including generally sucrose and reducing sugar.

Sweetness in the beer-like beverage according to the invention means that if the sweetness of sucrose is 100, this beverage is 9˜10.

The concentration of high fructose syrup used in the beer-like beverage according to the invention is 71%.

### 2. Technology

The beer-like beverage according to the invention can be prepared by the following steps:

(1) Pretreatment of soybean peptide powders. A proper amount of process water which has been heated to 85˜90 [symbol] is added into soybean peptide powders and acidity agents under stirring. The amount of process water must ensure that the pH value of the mixture obtained is 3.6˜3.8, and the concentration of soybean peptides is 7˜15%. After heated to 85˜90 [symbol] and filtered (e.g. by a plate filter), a filtrate is obtained and known as liquid A. The filtration pressure increases gradually from 0.03 MPa to 0.12 MPa during the filtration.

Alternatively, a proper amount of process water is added into soybean peptide powders under stirring to ensure the concentration of soybean peptides in the mixture obtained is 7˜15%. After filtered (e.g. by a membrane filter), the filtrate obtained is subjected to a 137 [symbol] instant sterilization and a 4S instant sterilization, and thus a filtrate is obtained and known as liquid A.

(2) Proportioning. Sweeteners are dissolved by a proper amount of process water with a temperature of 85˜90 [symbol] . Then the temperature is maintained at 94˜100 [symbol] for 20˜40 minutes; a proper amount of water is added into sodium carboxymethylcellulose, optional preservatives and other auxiliary materials, and the mixture is stirred for 10˜20 minutes to dissolve the materials and then added into liquid A; the dissolved sweeteners are also added into liquid A, and water is added to make the amount reach 100 parts by weight; the mixture is stirred for 10˜20 minutes. When test results of the sample show a pH value of 3.6˜4.8, refraction of 7.0˜8.0, total acid of 0.18˜4.0%, liquid temperature of 20˜25° C., the mixture is cooled to 2˜4° C. and denoted as liquid B.

(3) Carbonation. Liquid B is mixed with purified carbon dioxide whose pressure is maintained at 0.5˜0.8 MPa by CO₂ mixer under a back pressure of 0.32˜0.35 MPa and a carbonation pressure of 0.35˜0.38 MPa. When the carbon dioxide concentration in the liquid reaches 0.35˜0.5 (e.g. 0.4 parts by weight), liquid C is obtained. Alternatively, liquid B, whose temperature is decreased to 0˜2 [symbol] , is mixed with purified carbon dioxide whose pressure is maintained at 0.5˜0.8 MPa by titanium bars under a temperature of 0˜2 [symbol] and a pressure of 0.15˜0.2 MPa. When the temperature is maintained constantly for 5˜10 hours and the carbon dioxide concentration in the liquid reaches 0.35˜0.5 (e.g. 0.4 parts by weight), liquid C is obtained.

(4) Bottle filling and spray sterilization. Liquid C is filtered and bottle filled at 1˜4 [symbol] , preferably 1˜2 [symbol] . When the carbon dioxide content in the bottle reaches 0.35%, spray sterilization is performed.

In a preferred preparation method, when test results of the sample in step (2) show a pH value of 3.6˜3.8, refraction of 7.0˜8.0, total acid of 3.7˜4%, liquid temperature 20˜25° C., the liquid is cooled to 10˜12° C. by cold water (e.g. cold water having a temperature of 8˜10° C.), and is further cooled to 2˜4° C. by refrigerant (e.g., 20˜25% alcohol solution having a temperature of −3˜−6° C.). Liquid B is obtained.

In another preferred preparation method, the temperature of spray sterilization in step (4) is 63° C. and the duration is 10 minutes.

Prominent characteristics of the beer-like beverage according to the invention are as followings:

1. Appearance. Specific proportions of soybean peptide powder, sodium carboxymethylcellulose and carbon dioxide are selected to make foam lift to ½˜⅔ height of the cup when the beer-like beverage is poured into a cup. The foam is white, smooth and durable fine for 3˜5 minutes. After the rest of the beer-like beverage is opened and placed for 5˜10 hours, foam still lift when poured into a cup. The beer is light yellow, clear and transparent. It can be processed to prepare alcohol-free beer, alcohol beer and low-alcohol beer, as well as sugar beer, low-sugar beer and sugar-free beer. Flavoring agents such as juices and milk can also be added to make beer-like beverages of different tastes. Therefore, various market demands can be satisfied.

2. Aroma and taste. By adding phosphoric acid and adjusting pH values, the beer-like beverage is refreshing and has a fruit scent. It can provide pleasure feelings like drinking beer and no residues are left in the cup after drinking.

3. Functional action. The beer-like beverage according to the invention shows a new concept of functional beer. Peptides contained in the beer have the functions of anti-oxidation, prolonging the shelf life, anti-fatigue, reducing blood lipid and cholesterol, improving immunity, decreasing blood pressure, preventing tumor, loosing weight and so on. Long-term drinking is beneficial to the human body.

4. Continuous energy supply. The beer-like beverage according to the invention contains high fructose syrup and oligo-maltose. It can not only supply energy immediately, refresh and restore consciousness, but also provide energy continuously to make people feel relax and energetic.

Advantages of the preparation method according to the invention are as followings:

### 1. Advantages Compared With the Production Technology of Traditional Beer.

(Referring to Beer Industry Handbook, 1985 edition; compared with the scale of annual output of 50,000 tons). (1). Differences in production processes. Traditional fruit-flavor beer is prepared by adding juices, flavors and sugar into common beer, while the beer-like beverage of this invention is refined from soybean peptides, high fructose syrup, etc. No malt, saccharification, fermentation or yeast is necessary during the production process of this beer-like beverage. Except for spray sterilization, the production technology is completely different from the traditional way and is a whole new one. (2). Workshop and equipment saving. The investment of traditional beer production is 150 million yuan, while the beer-like beverage production of the same scale costs about 30 million yuan, which is only ⅕ of that of traditional beer. (3). Occupied area saving. ½ of the area can be saved. (4). Energy and resources saving. [symbol] Water. Water needed for traditional beer production is 1098.3 ton/hour, while 125 ton/hour is needed for beer-like beverage production, which is only ⅛ of that of traditional beer. It saves a lot of water, which is of great practical significance to the precious water resources nowadays. [symbol] Electricity. Installed capacity needed for traditional beer production is 7384 kW, while 560 kW is needed for beer-like beverage production, which is only 1/13 of that of traditional beer. [symbol] Steam. Steam energy needed for traditional beer production is 20,820 kcal/hour, while 6240 kcal/hour is needed for beer-like beverage production, which is only ⅓ of that of traditional beer. [symbol] Cooling capacity. Cooling capacity needed for traditional beer production is 2 million (1,994,190) kcal/hour, while 187.5 thousand kcal/hour is needed for beer-like beverage production, which is only 1/10 of that of traditional beer. [symbol] Grain saving. Barley, rice or corn needed for traditional beer production is 10 thousand tons, while 600 tons of soybean is needed for beer-like beverage production, (if alcohol beer-like beverage is produced, the amount of all the alcohol needed equals to 2000 tons of grain) therefore 2600 tons of grain is needed. The amount of grain needed for beer-like beverage production is only 30%˜50% of that of traditional beer, thus 50%˜70% grain can be saved. [symbol] Reduction of production staff. Half of the staff can be reduced. [symbol] Reduction of environmental protection investment. In the environmental protection aspect, beer-like beverage production is the same as common beverage production. Compared with traditional beer production, much investment is saved. [symbol] 0 Production period shortening. Even the period of fermentation in traditional beer production lasts 10˜15 days, while the whole period of beer-like beverage production is less than 2˜18 hours, which is 1/10 of that of traditional beer. Apparently, the production period is shortened greatly. The preparation of this invention has the advantages of simple production technology and much less resources consumption.

2. Other Advantages of the Production Technology of this Beer-Like Beverage.

(1) The preparation method according to the invention consists in mixing the mixed solution of complete materials with carbon dioxide and then pouring the mixture into a packaging container. Compared with the process of mixing the mixed solution of materials, water with carbon dioxide and then pouring the mixture obtained into a packaging container, the products produced by the method according to the present invention are mixed homogeneously to make sure the quality.

(2) Throughout the pretreatment of soybean peptide powders, a proper amount of process water which has been heated to 85˜90 [symbol] is added into soybean peptide powders and acidity agents. The pH value is adjusted to 3.6˜4.8 and the concentration of soybean peptides is 7˜15%. After heated to 85˜90 [symbol] and filtered (e.g. by a plate filter), a filtrate of soybean peptides is obtained in which high molecular protein and small molecular protein have been separated.

(3) Throughout the proportioning process, twice cooling is implemented. Ground water is used for the first cooling and the temperature is decreased to 10˜12° C. Then refrigerant is used for the second cooling and the temperature is decreased to 2˜4° C. The energy is fully utilized and the cost is saved.

(4) Throughout the carbonation process, the amount of carbon dioxide is ensured by selecting proper temperature and pressure in order to make the foam of the beverage abundant and delicious.

(5) Throughout the spray sterilization process, twice sterilization is implemented. The sterilization temperature is 63° C. and the duration is 10 minutes to ensure the product quality and decrease the total colony number of the product.

### EXAMPLES 1˜4

### Preparation of Beer-Like Beverages According to the Present Invention

In Examples 1˜4, 100 kg of beer-like beverage was prepared by the following methods using soybean peptide powder, sodium carboxymethylcellulose (CMC), high fructose syrup, oligo-maltose, sodium cyclamate, acesulfame potassium, citric acid, malic acid, phosphoric acid, sodium citrate, sodium benzoate, proper amount of carbon dioxide and balance of water. The weights of these materials are listed in Table 1.

(1) Pretreatment of soybean peptide powders. A proper amount of process water which had been heated to 85˜90 [symbol] was added into soybean peptide powders and acidity agents (citric acid, malic acid, phosphoric acid and sodium citrate) under stirring. A mixture was obtained whose pH value is 3.7 and the concentration of soybean peptides is 9%. After heated to 87 [symbol] and filtered by plate filter, a filtrate was obtained known as liquid A. The filtration pressure arises gradually from 0.03 MPa to 0.12 MPa during the filtration.

(2) Proportioning. Sweeteners (high fructose syrup, oligo-maltose, sodium cyclamate and acesulfame potassium) were dissolved by a proper amount of process water with a temperature of 85 [symbol] . Then the temperature was maintained at 94˜100 [symbol] for 30 minutes; a proper amount of water was added into sodium carboxymethylcellulose and other materials listed in Table 1 and the mixture was stirred for 10 minutes to dissolve the materials and then added into liquid A; the dissolved high fructose syrup, oligo-maltose, sodium cyclamate and acesulfame potassium was also added into liquid A, and water was added to make the amount reach 99.7 kg; the mixture was stirred for 10 minutes. When the test results of the sample show a pH value of 3.7, refraction of 7.5, total acid of 3.8%, liquid temperature of 25° C., the mixture was cooled to 10° C. by cold water having a temperature of 8° C. and further cooled to 2° C. by 25% alcohol solution having a temperature of −3° C. The mixture was denoted as liquid B.

(3) Carbonation. Liquid B was mixed with purified carbon dioxide whose pressure was maintained at 0.6 MPa by CO₂ mixer under a back pressure of 0.32˜0.35 MPa and a carbonation pressure of 0.35˜0.38 MPa. When the carbon dioxide content in the liquid had reached 0.4%, liquid C was obtained.

(4) Bottle filling and spray sterilization. Liquid C was filtered and bottle filled at 1˜2 [symbol] . When the carbon dioxide content reaches 0.35% or more, spray sterilization is implemented.

TABLE 1
Amount of source materials

| source materials | | | | |
|---|---|---|---|---|
| (unit g) | Example 1 | Example 2 | Examples 3 | Examples 4 |
| soybean peptide | 500 | 600 | 700 | 800 |
| powder | | | | |
| CMC | 120 | 100 | 80 | 60 |
| high fructose syrup | 6500 | 6500 | 6500 | 6500 |
| oligo-maltose | 2000 | 2000 | 2000 | 2000 |
| sodium cyclamate | 60 | 60 | 60 | 60 |
| acesulfame | 5 | 5 | 5 | 5 |
| potassium | | | | |
| citric acid | 180 | 180 | 180 | 180 |
| malic acid | 103.5 | 103.5 | 103.5 | 103.5 |
| phosphoric acid | 20 | 20 | 20 | 20 |
| sodium citrate | 10 | 10 | 10 | 10 |
| sodium benzoate | 15 | 15 | 15 | 15 |

Sensory properties, physicochemical properties and microbial properties of the beer-like beverage prepared in Examples 1˜4 are tested and the results are listed in Table 2˜4.

TABLE 2
Sensory properties*

| item | | Example 1 | Example 2 | Example 3 | Example 4 |
|---|---|---|---|---|---|
| color, taste, odor | | specific beer | specific beer | specific beer | specific beer |
| | | color, pure | color, pure | color, pure | color, pure |
| | | and | and | and | and |
| | | pleasurable | pleasurable | pleasurable | pleasurable |
| | | taste, | taste, | taste, | taste, |
| | | refreshing, | refreshing, | refreshing, | refreshing, |
| | | soft, no | soft, no | soft, no | soft, no |
| | | peculiar | peculiar | peculiar | peculiar |
| | | smell or | smell or | smell or | smell or |
| | | flavor | flavor | flavor | flavor |
| foam | morphology | white, | white, | white, | white, |
| | | durable fine | durable fine | durable fine | durable fine |
| | | and smooth | and smooth | and smooth | and smooth |
| | bubble | 180 | 180 | 180 | 180 |
| | duration*, | | | | |
| | S≧ | | | | |

| | | | | |
|---|---|---|---|---|
| transparency | clear and | clear and | clear and | clear and |
| | transparent, | transparent, | transparent, | transparent, |
| | some visible | some visible | some visible | some visible |
| | micro | micro | micro | micro |
| | suspended | suspended | suspended | suspended |
| | matters and | matters and | matters and | matters and |
| | small amount | small amount | small amount | small amount |
| | of | of | of | of |
| | precipitates | precipitates | precipitates | precipitates |
| | (not foreign | (not foreign | (not foreign | (not foreign |
| | bodies) | bodies) | bodies) | bodies) |

*Bubble duration is an index of the stability of beer foam.
*The results of sensory properties come from a 5-people assess group.

TABLE 3
Physicochemical properties

| item | Example 1 | Example 2 | Example 3 | Example 4 |
|---|---|---|---|---|
| total acid % | 0.36 | 0.35 | 0.33 | 0.32 |
| solid % | 7.3 | 7.4 | 7.5 | 7.6 |
| pH value | 3.67 | 3.69 | 3.71 | 3.72 |
| protein mg/100 ml | 468 | 572 | 680 | 786 |
| wherein peptide | 153 | 187 | 236 | 279 |
| mg/100 ml | | | | |
| carbon dioxide % | 0.37 | 0.41 | 0.38 | 0.39 |
| (m/m) | | | | |
| alcohol %(m/m) | 0 | 0 | 0 | 0 |

TABLE 4
Microorganism detection

| item | Example 1 | Example 2 | Example 3 | Example 4 |
|---|---|---|---|---|
| colony count, cfu/ml | 50 | 45 | 30 | 66 |
| coliform group, | not | not | not detected | not detected |
| MPN/100 ml | detected | detected | | |
| yeast, cfu/ml | not | not | not detected | not detected |
| | detected | detected | | |
| mould, cfu/ml | not | not | not detected | not detected |
| | detected | detected | | |
| pathogenic bacteria | not | not | not detected | not detected |
| (salmonella, | detected | detected | | |
| shigella, | | | | |
| staphylococcus | | | | |
| aureus, hemolytic | | | | |
| streptococcus) | | | | |

### COMPARISON EXAMPLES 1˜4

Following the preparation methods mentioned in Examples 1˜4, soybean peptide powder, CMC, high fructose syrup, oligo-maltose, sodium cyclamate, acesulfame potassium, citric acid, malic acid, phosphoric acid, sodium citrate, sodium benzoate, proper amount of carbon dioxide and water were used to prepare contrast beverages. The weights of these materials are listed in Table 5:

TABLE 5
Amount of source materials

| | com- | com- | com- | |
|---|---|---|---|---|
| source materials | parison | parison | parison | comparison |
| (unit g) | example 1 | example 2 | example 3 | example 4 |
| soybean peptide | 100 | 1000 | 100 | 1000 |
| powder | | | | |
| CMC | 20 | 200 | 200 | 20 |
| high fructose syrup | 6500 | 6500 | 6500 | 6500 |
| oligo-maltose | 2000 | 2000 | 2000 | 2000 |
| sodium cyclamate | 60 | 60 | 60 | 60 |
| acesulfame potassium | 5 | 5 | 5 | 5 |
| citric acid | 180 | 180 | 180 | 80 |
| malic acid | 180 | 103.5 | 103.5 | 80 |
| phosphoric acid | 20 | 20 | 20 | 20 |
| sodium citrate | 10 | 10 | 10 | 10 |
| sodium benzoate | 15 | 15 | 15 | 15 |

Sensory properties and physicochemical properties of the beverage prepared in comparison examples 1˜4 were tested and results are listed in Table 6 and 7.

TABLE 6
Sensory properties of comparison beverage

| | comparison | | | |
|---|---|---|---|---|
| | example | | | |
| | comparison | comparison | comparison | comparison |
| | example 1 | example 2 | example 3 | example 4 |
| sensory | little foam, | too much | little foam, | too much |
| properties | short duration | foam, short | long bubble | foam, too |
| | of foam, | bubble | duration | long bubble |
| | strong taste, | duration | | duration, not |
| | not soft | | | refreshing |

TABLE 7
Physicochemical properties

| | com- | | | |
|---|---|---|---|---|
| | parison | comparison | comparison | comparison |
| item | example 1 | example 2 | example 3 | example 4 |
| total acid % | 0.46 | 0.29 | 0.40 | 0.18 |
| solid % | 6.7 | 8.1 | 6.7 | 8.0 |
| pH value | 3.59 | 3.74 | 3.63 | 4.58 |
| protein | 167 | 974 | 183 | 989 |
| mg/100 ml | | | | |
| wherein peptide | 54 | 338 | 65 | 354 |
| mg/100 ml | | | | |
| carbon dioxide | 0.40 | 0.41 | 0.38 | 0.40 |
| % (m/m) | | | | |
| alcohol % (m/m) | 0 | 0 | 0 | 0 |

### EXAMPLES 5˜8

Following the preparation methods in Examples 1˜4, soybean peptide powder, CMC, high fructose syrup, oligo-maltose, sodium cyclamate, acesulfame potassium, citric acid, malic acid, phosphoric acid, sodium citrate, 95% edible alcohol, sodium benzoate, proper amount of carbon dioxide and water were used to prepare 100 kg of alcohol-contained beer-like beverages. The weights of these materials are listed in Table 8. Among them, step (3) was performed as followings: liquid B, whose temperature was decreased to 2 [symbol] , was mixed with purified carbon dioxide whose pressure was maintained at 0.6 MPa by titanium bars under a temperature of 2 [symbol] and a pressure of 0.15˜0.2 MPa. When the temperature was maintained constantly for 5 hours and the carbon dioxide content in the liquid reached 0.45%, liquid C was obtained.

TABLE 8
Amount of source materials

| source materials | | | | |
|---|---|---|---|---|
| (unit g) | Example 5 | Example 6 | Example 7 | Example 8 |
| soybean peptide | 500 | 600 | 700 | 800 |
| powder | | | | |
| CMC | 120 | 100 | 80 | 60 |
| high fructose syrup | 6500 | 6500 | 6500 | 6500 |
| oligo-maltose | 2000 | 2000 | 2000 | 2000 |
| sodium cyclamate | 60 | 60 | 60 | 60 |
| acesulfame potassium | 5 | 5 | 5 | 5 |
| citric acid | 180 | 180 | 180 | 180 |
| malic acid | 103.5 | 103.5 | 103.5 | 103.5 |
| phosphoric acid | 20 | 20 | 20 | 20 |
| sodium citrate | 10 | 10 | 10 | 10 |
| sodium benzoate | 15 | 15 | 15 | 15 |
| 95% edible alcohol | 525 | 1050 | 2100 | 3150 |

Physicochemical properties of the alcohol-contained beer-like beverages were tested and results are listed in Table 9.

TABLE 9
Physicochemical properties of the alcohol-contained
beer-like beverages

| item | Example 5 | Example 6 | Example 7 | Example 8 |
|---|---|---|---|---|
| total acid % | 0.36 | 0.35 | 0.33 | 0.32 |
| solid % | 7.3 | 7.4 | 7.5 | 7.6 |
| pH value | 3.67 | 3.69 | 3.71 | 3.72 |
| alcohol %(m/m) | 0.5 | 1 | 2 | 3 |
| protein (mg/100 ml) | 468 | 572 | 680 | 786 |
| peptide (mg/100 ml) | 153 | 187 | 236 | 279 |
| carbon dioxide | 0.37 | 0.41 | 0.38 | 0.39 |
| % (m/m) | | | | |

### EMBODIMENT 9˜12

Fruit beer-like beverages were prepared based on Examples 1˜4

TABLE 10
Amount of source materials

| source materials | | Example | Example | Example |
|---|---|---|---|---|
| (unit g) | Example 9 | 10 | 11 | 12 |
| soybean protein | 500 | 600 | 700 | 800 |
| peptide | | | | |
| CMC | 120 | 100 | 80 | 60 |
| High fructose syrup | 6500 | 6500 | 6500 | 6500 |
| Oligo-maltose | 2000 | 2000 | 2000 | 2000 |
| sodium cyclamate | 60 | 60 | 60 | 60 |
| acesulfame potassium | 5 | 5 | 5 | 5 |
| citric acid | 180 | 180 | 180 | 180 |
| malic acid | 103.5 | 103.5 | 103.5 | 103.5 |
| phosphoric acid | 20 | 20 | 20 | 20 |
| sodium citrate | 10 | 10 | 10 | 10 |
| sodium benzoate | 15 | 15 | 15 | 15 |
| edible alcohol | 525 | 1050 | 2100 | 3150 |
| Other flavorings | honey | mango | fresh milk | watermelon |
| | peach | juice | 10000 | juice |
| | flavor | 20000 | | 5000 |
| | 40 | | | |

### EXAMPLES 13˜16

Sugar-free beer-like beverages were prepared. Source materials were used based on Examples 1˜4, while high fructose syrup and oligo-maltose were replaced by sucralose and the amount of acesulfame potassium was increased.

Specifically speaking, following the preparation methods in Examples 1˜4, 100 kg of sugar-free beer-like beverages was prepared. The weights of source materials are listed in Table 11.

The term “sugar-free” here means no sucrose is added into the beverage during the preparation process.

TABLE 11
Amount of source materials

| source materials | Example | | | |
|---|---|---|---|---|
| (unit g) | 13 | Example 14 | Example 15 | Example 16 |
| soybean protein | 500 | 600 | 700 | 800 |
| peptide | | | | |
| CMC | 120 | 100 | 80 | 60 |
| sucralose | 3.8 | 3.8 | 3.8 | 3.8 |
| sodium cyclamate | 60 | 60 | 60 | 60 |
| acesulfame | 20 | 20 | 20 | 20 |
| potassium | | | | |
| citric acid | 180 | 180 | 180 | 180 |
| malic acid | 103.5 | 103.5 | 103.5 | 103.5 |
| phosphoric acid | 20 | 20 | 20 | 20 |
| sodium citrate | 10 | 10 | 10 | 10 |
| sodium benzoate | 15 | 15 | 15 | 15 |
| 95% edible | 525 | 1050 | 2100 | 3150 |
| alcohol | | | | |

### EXAMPLES 17˜20

Beer-like beverages were prepared. Source materials were used based on Examples 1˜4, and auxiliary materials were added. Step (1) was performed as followings: a proper amount of process water was added into soybean peptide powders under stirring to ensure the concentration of soybean peptide was 12%. After filtered by membrane filter, 137 [symbol] instant sterilized and 4S instant sterilized, a filtrate was obtained and denoted as liquid A. Other processes were performed according to the preparation methods in Examples 1˜4. 100 kg of beer-like beverages was prepared by source materials whose weights are listed in Table 12.

TABLE 12
Amount of source materials

| source materials | | | | |
|---|---|---|---|---|
| (unit g) | Example 17 | Example 18 | Example 19 | Example 20 |
| soybean protein | 500 | 600 | 700 | 800 |
| peptide | | | | |
| CMC | 150 | 100 | 80 | 60 |
| high fructose syrup | 6500 | 7000 | 2000 | 3500 |
| oligo-maltose | 2000 | 3000 | 6500 | 5000 |
| sodium cyclamate | 60 | 60 | 60 | 60 |
| acesulfame | 5 | 5 | 5 | 5 |
| potassium | | | | |
| citric acid | 180 | 80 | 130 | 180 |
| malic acid | 103.5 | 130 | 90 | 120 |
| phosphoric acid | 20 | 10 | 15 | 20 |
| sodium citrate | 10 | 10 | 10 | 10 |
| sodium benzoate | 15 | 20 | 10 | 15 |
| edible alcohol | 525 | 1050 | 2100 | 3150 |
| Other flavorings | L-carnitine | Vitamin C 24 | Ginsenoside 1 | Honey 3 |
| | tartaric acid 75 | | Vitamin B6 1 | Wheat flavor 7 |
| | | | | Baked barley 3 |

### EXAMPLE 21

Source materials: 0.5 g of soybean peptide powder, 0.06 g of sodium carboxymethylcellulose, 2 g of high fructose syrup having a concentration of 71%, 0.04 g of sodium cyclamate, 0.005 g of acesulfame potassium, 0.15 g of citric acid, 0.01 g of phosphoric acid, 0.01 g of sodium citrate, 0.4˜0.65 g of carbon dioxide and balance of water.

### Preparation:

(1) Pretreatment of soybean peptide powders: a proper amount of process water which has been heated to 85˜90 [symbol] was added into 0.5 g of soybean peptide powders and acidity agents (0.15 g of citric acid, 0.01 g of phosphoric acid, 0.01 g of sodium citrate) under stirring. The amount of process water must ensure that the pH value of the mixture was 4.2, and the concentration of soybean peptides was 13%. After heated to 90 [symbol] and filtered by plate filter, a filtrate was obtained and denoted as liquid A. The filtration pressure increases gradually from 0.03 MPa to 0.12 MPa during the filtration.

(2) Proportioning: Sweeteners (2 g of 71% high fructose syrup, 0.04 g of sodium cyclamate, 0.005 g of acesulfame potassium) were dissolved by a proper amount of process water with a temperature of 90 [symbol] . Then the temperature was maintained at 100° C. for 30 minutes; a proper amount of water was added into 0.06 g of sodium carboxymethylcellulose, and the mixture was stirred for 10˜20 minutes to dissolve and then added into liquid A; the dissolved sweeteners were also added into liquid A, and water was added to make the amount reach 100 g; the mixture was stirred for 10˜20 minutes. When test results of the sample show a pH value of 4.2, refraction of 8.0, total acid of 0.18%, liquid temperature of 20° C., the mixture was cooled to 2° C. and denoted as liquid B.

(3) Carbonation: Liquid B was mixed with purified carbon dioxide whose pressure is maintained at 0.5˜0.8 MPa by CO₂ mixer under a back pressure of 0.32˜0.35 MPa and a carbonation pressure of 0.35˜0.38 MPa. When the carbon dioxide content in liquid reached 0.35˜0.5 g (e.g. 0.4 g), liquid C was obtained.

(4) Bottle filling and spray sterilization: Liquid C was filtered and bottle filled at 1˜4 [symbol] , preferably 1˜2° C. When the carbon dioxide content in the bottle reached 0.35%, spray sterilization was implemented.

1. A beer-like beverage that is a mixture comprising, in terms of 100 parts by weight of the beverage, at least the following materials:
0.2˜0.9 parts by weight of soybean peptide powder, 0.05˜0.15 parts by weight of sodium carboxymethylcellulose (CMC), 0.30˜0.65 parts by weight of carbon dioxide, 1.5˜10 parts by weight of sweeteners, 0.006˜0.3% parts by weight of acidity agents and balance of water.

2. The beer-like beverage according to claim 1, wherein the beverage comprises 0.2˜0.5 parts by weight of soybean peptide powder, 0.05˜0.15 parts by weight of sodium carboxymethylcellulose, 0.4˜0.65 parts by weight of carbon dioxide, 1.55˜2.65 parts by weight of sweeteners, 0.006˜0.3% parts by weight of acidity agents and balance of water.

3. The beer-like beverage according to claim 1, wherein the beverage has a pH value of 3.6˜4.8, total acid of 0.18˜0.40 parts by weight, total sugar of less than 5 parts by weight, and sweetness of 9˜10°.

4. The beer-like beverage according to claim 1, wherein the mixture comprises 0.2˜0.8 parts by weight of soybean peptide powder, 0.05˜0.15 parts by weight of sodium carboxymethylcellulose, 1.5˜7 parts by weight of high fructose syrup having a concentration of 71%, 0.04˜0.15 parts by weight of sodium cyclamate, 0.004˜0.005 parts by weight of acesulfame potassium, 0.01˜0.2 parts by weight of citric acid, 0.005˜0.025 parts by weight of phosphoric acid, 0.001˜0.02 parts by weight of sodium citrate, 0.4˜0.65 parts by weight of carbon dioxide and balance of water.

5. The beer-like beverage according to claim 4, the following substances can be added to the above-mentioned materials: 2 parts by weight of oligo-maltose, 0.1035 parts by weight of malic acid, 0.015 parts by weight of sodium benzoate, 0.0687 parts by weight of food flavors and 0.00025 parts by weight of natural pigment.

6. The beer-like beverage according to claim 5, wherein the mixture comprises 0.5˜0.8 parts by weight of soybean peptide powder, 0.05˜0.15 parts by weight of sodium carboxymethylcellulose, 6˜7 parts by weight of high fructose syrup having a concentration of 71%, 2 parts by weight of oligo-maltose, 0.04˜0.06 parts by weight of sodium cyclamate, 0.004˜0.005 parts by weight of acesulfame potassium, 0.15˜0.2 parts by weight of citric acid, 0.1035 parts by weight of malic acid, 0.01˜0.02 parts by weight of phosphoric acid, 0.01˜0.02 parts by weight of sodium citrate, 0.015 parts by weight of sodium benzoate, 0.0687 parts by weight of food flavors and 0.00025 parts by weight of natural pigment.

7. The beer-like beverage according to claim 1, wherein the mixture comprises 0.725 parts by weight of soybean peptide powder, 0.06 parts by weight of sodium carboxymethylcellulose, 6.5 parts by weight of high fructose syrup having a concentration of 71%, 2 parts by weight of oligo-maltose, 0.06 parts by weight of sodium cyclamate, 0.005 parts by weight of acesulfame potassium, 0.18 parts by weight of citric acid, 0.1035 parts by weight of malic acid, 0.02 parts by weight of phosphoric acid, 0.01 parts by weight of sodium citrate, 0.015 parts by weight of sodium benzoate, 0.0687 parts by weight of food flavors and 0.00025 parts by weight of natural pigment.

8. A method for preparing the beer-like beverage according to claim 1, which comprises the following steps:
(1) Pretreatment of soybean peptide powders: adding a proper amount of process water which has been heated to 85˜90° C. into soybean peptide powders and 0.2˜0.3 parts by weight of acidity agents under stirring, the amount of process water must ensure that a mixture is obtained that has a pH value of 3.6˜4.8 and a concentration of soybean peptides of 7˜15%; heating the mixture to 85˜90° C., and then filtering the mixture to obtain a filtrate known as liquid A;
(2) Proportioning: dissolving sweeteners by a proper amount of process water with a temperature of 85˜90° C. and maintaining the temperature at 90˜95° C. for 20˜40 minutes; adding a proper amount of process water into sodium carboxymethylcellulose and a proper amount of optional preservatives and other auxiliary materials, stirring for 10˜20 minutes to dissolve them and adding the mixture obtained into liquid A; adding also the dissolved sweeteners into liquid A, and adding water to make the amount reach 100 parts by weight; stirring the mixture for 10˜20 minutes; and cooling the mixture to 2˜4° C. to obtain a mixture known as liquid B;
(3) Carbonation: mixing liquid B with purified carbon dioxide whose pressure is maintained at 0.5˜0.8 MPa by CO₂ mixer under a back pressure of 0.32˜0.35 MPa and a carbonation pressure of 0.35˜0.38 MPa, until the carbon dioxide content in liquid B reaches 0.35˜0.5% (e.g. 0.4%) to obtain liquid C; alternatively, decreasing the temperature of liquid B to 0˜2° C., then mixing liquid B with purified carbon dioxide whose pressure is maintained at 0.5˜0.8 MPa by titanium bars under a temperature of 0˜2° C. and a pressure of 0.15˜0.2 MPa, maintaining the temperature constantly for 5˜10 hours, until the carbon dioxide content in liquid B reaches 0.30˜0.5% (e.g. 0.4%) to obtain liquid C;
(4) Bottle filling and spray sterilization: filtering liquid C and bottle filling it at 1˜4° C., preferably at 1˜2° C.; performing spray sterilization when the carbon dioxide content in the bottle reaches 0.35% or more.

9. The method according to claim 8, step (1) can be replaced by carrying out the following procedures: adding a proper amount of process water into 0.3˜0.9 parts by weight, preferably 0.5˜0.8 parts by weight of soybean peptide powders under stirring to ensure that a mixture having a concentration of soybean peptides of 7˜15% is obtained; filtering the mixture (e.g. by a membrane filter) to obtain a filtrate, subjecting the filtrate to a 137° C. instant sterilization and a 4S instant sterilization to obtain a filtrate known as liquid A.

10. The method according to claim 8, wherein during filtration carried out in step (1), the filtration pressure increases gradually from 0.03 MPa to 0.12 MPa to obtain a filtrate known as liquid A.

11. The method according to claim 8, wherein the mixture in step (2) is stirred for 10˜20 minutes and the sample has a pH value of 3.6˜4.8, refraction of 7.0˜8.0, total acid of 0.18˜4.0% and a liquid temperature of 20˜25° C.

12. The method according to claim 8, wherein cooling the mixture to 2˜4° C. in step (2) means cooling the liquid to 10˜12° C. by cold water having a temperature of 8˜10° C., and further cooling to 2˜4° C. by refrigerant (e.g. 20˜25% alcohol solution having a temperature of −3˜−6° C.), so that liquid B is obtained.

13. The method according to claim 8, wherein the temperature of spray sterilization in step (4) is 63° C. and the duration is 10 minutes.

14. The beer-like beverage according to claim 2, wherein the beverage has a pH value of 3.6˜4.8, total acid of 0.18˜0.40 parts by weight, total sugar of less than 5 parts by weight, and sweetness of 9˜10°.
